(19) United States
(12) Patent Application Publication
(10) Pub. No.: US 2020/0003887 A1
(43) Pub. Date: Jan. 2, 2020

(54) SPEED MEASUREMENT DEVICE AND SPEED MEASUREMENT METHOD

(71) Applicant: HITACHI AUTOMOTIVE SYSTEMS, LTD., Ibaraki (JP)

(72) Inventors: Takafumi MATSUMURA, Hitachinaka-shi (JP); Masayuki SATOU, Hitachinaka-shi (JP)

(73) Assignee: HITACHI AUTOMOTIVE SYSTEMS, LTD., Ibaraki (JP)

(21) Appl. No.: 16/490,805

(22) PCT Filed: Jan. 25, 2018
(86) PCT No.: PCT/JP2018/002203

§ 371 Date: Sep. 3, 2019

(30) Foreign Application Priority Data
Mar. 9, 2017 (JP) 2017-044721

(51) Int. Cl. G01S 13/60; G01S 15/60

(52) U.S. Cl. CPC G01S 13/60; B60W 2420/52; G01S 15/60

(57) ABSTRACT

A speed measurement device and a speed measurement method are proposed which can calculate a speed even in a case where an intensity of a reflection wave is weakened with respect to an irradiation wave emitted from a radar module. A speed measurement device mounted in a vehicle generates an irradiation wave to emit the wave to a ground, receives a reflection wave from the ground of the irradiation wave, and generates a frequency difference signal between the emitted irradiation wave and the received reflection wave. Then, in a case where the intensity of the generated frequency difference signal is equal to or more than a predetermined value (amplitude threshold), a measurement speed is calculated on the basis of the frequency difference signal. Further, in the speed measurement device, the amplitude threshold used at the time of next measuring is changed based on a state of a system.

### TECHNICAL FIELD

The present invention relates to a speed measurement device and a speed measurement method, and is desirably applied to a speed measurement device and a speed measurement method to measure a speed of a vehicle.

### BACKGROUND ART

As a method of measuring a ground speed (in the description below, denoted as “speed” if not otherwise specified) of the vehicle such as an automobile and a railway train, there is a general method of measuring a rotation speed of the wheel of the vehicle to obtain the speed. However, it is known in this method that the speed cannot be measured when the wheel slips, and a measurement error occurs while the diameter of the wheel is changed by a loading situation of people and luggage and an air leaking of a tire.

On the other hand, there is known a method of measuring the speed of the vehicle using a radar speedometer (for example, PTL 1). In such a speed measurement method, the radar speedometer is a speed measurement device which includes a radar module of a millimeter wave band and a microwave band. An electromagnetic wave is continuously emitted from the radar module toward a traveling path to receive a reflection wave, and the change in frequency of the reflection wave caused by the Doppler effect is measured to calculate the speed. Then, the speed measurement method has an advantage that the speed can be measured even when the wheel slips, and the measurement error is also not caused by the change in diameter of the wheel.

### CITATION LIST

### Patent Literature

PTL 1: JP 2006-184144 A

### SUMMARY OF INVENTION

### Technical Problem

However, in the speed measurement method disclosed in PTL 1, the intensity of the reflection wave received by the radar speedometer may be weakened depending on the state of the traveling path. In this case, the calculation of the speed is difficult.

The invention has been made in view of the above points, and proposes a speed measurement device and a speed measurement method which can calculate the speed even in a case where the intensity of the reflection wave is weakened with respect to an irradiation wave emitted from the radar module.

### Solution to Problem

According to the invention to solve the above problem, there is provided a speed measurement device which measures a speed of a mounted system. The device includes an irradiation unit which generates an irradiation wave to emit the wave to an object, a reception unit which receives a reflection wave from the object of the emitted irradiation wave, a signal generation unit which generates a frequency difference signal which indicates a frequency difference between the irradiation wave generated by the irradiation unit and the reflection wave received by the reception unit, a speed calculation unit which calculates a measurement speed on the basis of the frequency difference signal in a case where an intensity of the frequency difference signal generated by the signal generation unit is equal to or more than a predetermined value, and a threshold chance unit which changes the predetermined value used in the speed calculation unit when measuring a speed next time on the basis of a state of the system.

In addition, according to the invention to solve the above problem, there is provided a speed measurement method of a speed measurement device which measures a speed of a mounted system. The method includes an emitting step of generating an irradiation wave to emit the wave to an object, a receiving step of receiving a reflection wave from the object of the irradiation wave emitted in the emitting step, a signal generating step of generating a frequency difference signal indicating a frequency difference between the irradiation wave generated in the emitting step and the reflection wave received in the receiving step, a speed calculating step of calculating a measurement speed on the basis of the frequency difference signal in a case where an intensity of the frequency difference signal generated in the signal generating step is equal to or more than a predetermined value, and a threshold changing step of changing the predetermined value used in the speed calculating step when measuring a speed next time on the basis of a state of the system.

### Advantageous Effects of Invention

According to the invention, a speed can be calculated even in a case where an intensity of a reflection wave is weakened with respect to an irradiation wave emitted from a radar module.

### BRIEF DESCRIPTION OF DRAWINGS

FIG. 1 is a diagram illustrating an example of a vehicle where a speed measurement device according to a first embodiment of this invention.

FIG. 2 is a diagram illustrating a configuration example of the speed measurement device illustrated in FIG. 1.

FIG. 3 is a flowchart illustrating a procedure example of a calculation processing of a measurement speed in the speed measurement device.

FIG. 4 is a diagram for describing an example of an amplitude spectrum when the vehicle is in a “stopped state”.

FIG. 5 is a diagram for describing an example of the amplitude spectrum when the vehicle is in a “traveling state”.

FIG. 6 is a diagram for describing an example of the amplitude spectrum in a case where the vehicle is in the “traveling state” and the intensity of a reflection wave is weak due to the state of a traveling path.

FIG. 7 is a diagram (Part 1) for describing a relation between a boundary speed and an amplitude threshold.

FIG. 8 is a diagram (Part 2) for describing the relation between the boundary speed and the amplitude threshold.

FIG. 9 is a flowchart illustrating a procedure example of a determining process of the amplitude threshold in a second embodiment.

FIG. 10 is a diagram for describing an irradiation range of an electromagnetic wave which is emitted from the speed measurement device.

FIG. 11 is a diagram illustrating an example of the amplitude spectrum after FFT processing.

FIG. 12 is a diagram for describing an example of the amplitude spectrum in a case where there is a jitter in the traveling state.

FIG. 13 is a diagram for describing an example of the amplitude spectrum in a case where the intensity of the jitter is strong in the stopped state.

FIG. 14 is a diagram for describing an example of the amplitude spectrum in a case where the intensity of the jitter is strong in the traveling state.

FIG. 15 is a diagram (Part 1) illustrating a configuration example of the speed measurement device according to a fourth embodiment.

FIG. 16 is a diagram (Part 1) illustrating an example of the vehicle according to the fourth embodiment.

FIG. 17 is a diagram (Part 2) illustrating an example of the vehicle according to the fourth embodiment.

FIG. 18 is a diagram (Part 2) illustrating a configuration example of the speed measurement device according to the fourth embodiment.

FIG. 19 is a diagram (Part 3) illustrating an example of the vehicle according the fourth embodiment.

FIG. 20 is a diagram illustrating a relation example between the angle of pitching and a Doppler frequency change amount.

FIG. 21 is a diagram for describing a relation of a calculation value of the measurement speed in a case where the measurement timing is not matched.

FIG. 22 is a diagram for describing a relation of the calculation value of the measurement speed in a case where the measurement timing is matched.

FIG. 23 is a diagram (Part 4) illustrating an example of the vehicle according the fourth embodiment.

### DESCRIPTION OF EMBODIMENTS

Hereinafter, a speed measurement device and a speed measurement method according to embodiments of the invention will be described with reference to the drawings.

Further, in the following description, examples of a vehicle where the speed measurement device is mounted include an automobile and a railway vehicle. In a case where the vehicle is an automobile, the ground such as an asphalt road surface can be a traveling path. In a case where the vehicle is a railway train, the railway can be a traveling path. In addition, the speed measurement device will be described by taking an example of a device which uses the Doppler effect in a millimeter wave band and a microwave band. However, the speed measurement device according to the invention may be applied to a speed measurement device which uses the Doppler effect in sonic waves such as ultrasonic waves. Further, these speed measurement devices may be used as a means for measuring a speed of the vehicle passing through the traveling path on the road.

### (1) First Embodiment

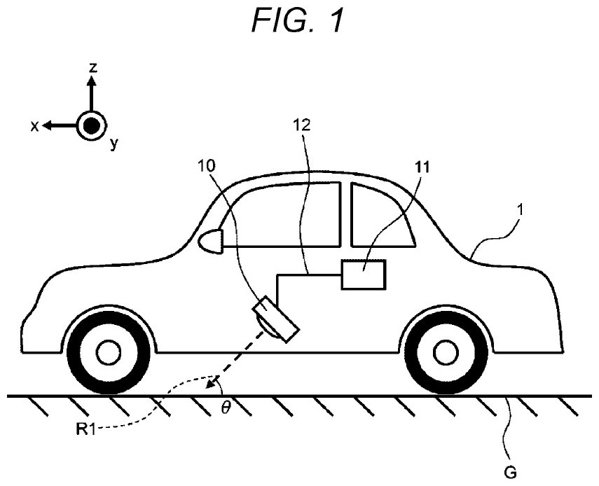

FIG. 1 is a diagram illustrating an example of the vehicle where the speed measurement device according to a first embodiment of this invention. FIG. 1 illustrates a vehicle 1 which travels on the ground G (traveling path). The vehicle 1 includes a speed measurement device 10 which calculates the speed of the vehicle 1, an external device 11 which is a host control system in the vehicle 1, and a communication line 12 through which the speed measurement device 10 and the external device 11 are connected and can perform signal communication. Further, since there is no need to illustrate all the configurations of the vehicle 1 in FIG. 1, the configuration of the speed measurement device 10 in the vehicle 1 is illustrated schematically. In addition, in FIG. 1, the speed measurement device 10 is disposed in the vehicle 1 such that an emitting electromagnetic wave R1 is propagated in an xz plane, and incident on the ground G at an angle θ.

The speed measurement device 10 receives a reflection wave while emitting the electromagnetic wave R1 toward the traveling path, and calculates the speed of the vehicle 1 on the basis of the change in frequency. A signal indicating the speed calculated by the speed measurement device 10 is transmitted to the external device 11 through the communication line 12. Then, the external device 11 can perform a predetermined control in the vehicle 1 on the basis of the speed information obtained from the speed measurement device 10. As an example of the external device 11, an automatic speed control device may be considered.

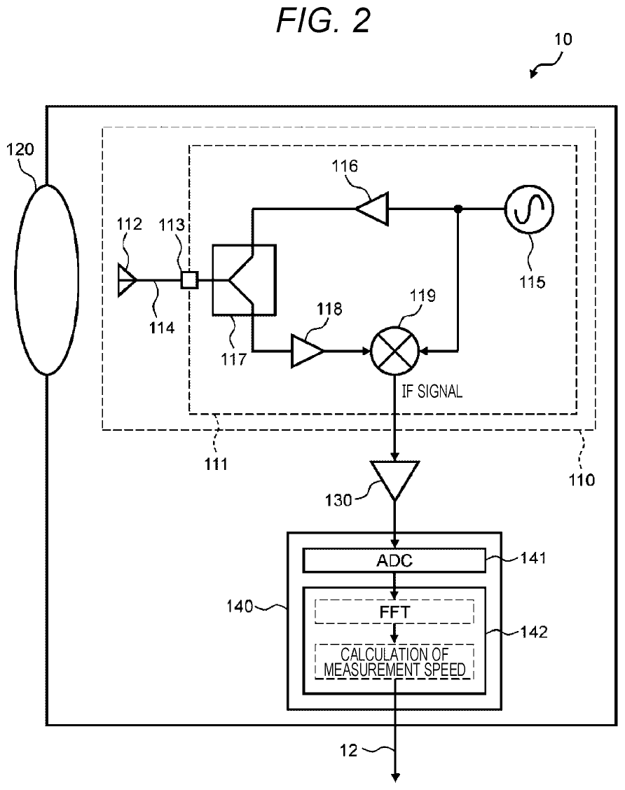

FIG. 2 is a diagram illustrating a configuration example of the speed measurement device illustrated in FIG. 1. As illustrated in FIG. 2, the speed measurement device 10 mainly includes a millimeter wave radar module 110, a lens 120, an IF signal amplifier 130, and a calculation circuit 140.

Further, in this embodiment, as an example of the radar module mounted in the speed measurement device 10, the millimeter wave radar module 110 which emits 77 GHz electromagnetic wave (millimeter wave) will be described. However, the radar module applicable to the speed measurement device 10 according to the invention is not limited to the millimeter wave radar module 110. For example, a radar module which emits the electromagnetic wave in at least any one of a quasi-millimeter wave band, a millimeter wave band, and a microwave band.

According to FIG. 2, the millimeter wave radar module 110 includes an IC chip 111 which generates a radio frequency signal for the emission electromagnetic wave and performs signal processing on a reflection electromagnetic wave (reflection wave), and an antenna 112 which emits the electromagnetic wave and receives the reflection electromagnetic wave. The antenna 112 and the IC chip 111 (a port 113) are connected by a feeder line 114. More specifically describing the configuration, the IC chip 111 is configured to include an oscillator 115, a transmission amplifier 116, an isolator 117, a reception amplifier 118, and a mixer 119 besides the port 113.

The port 113 is connected to the isolator 117. The electromagnetic wave is emitted from the port 113 through the antenna 112, and incident on the lens 120.

In addition, the mixer 119 mixes the signal of reflection electromagnetic wave received by the antenna 112 and the radio frequency signal output from the oscillator 115 to generate an IF (Intermediate Frequency) signal. The generated IF signal is incident on the IF signal amplifier 130.

The lens 120 has a role of focusing the electromagnetic wave (the reflection electromagnetic wave, the reflection wave) reflected on the ground G to emit the wave to the antenna 112 in addition to the role of focusing the electromagnetic wave emitted from the antenna 112 of the millimeter wave radar module 110 to emit the wave to the ground G as the electromagnetic wave R1.

The IF signal amplifier 130 amplifies the IF signal incident from the mixer 119 of the millimeter wave radar module 110, and inputs the signal to the calculation circuit 140.

The calculation circuit 140 includes an AD converter (ADC: Analog to Digital Converter) 141 which converts the analog IF signal input from the IF signal amplifier 130 into a digital signal, and a CPU (Central Processing Unit) 142 which performs a fast Fourier transform (FFT) processing on the IF signal converted into the digital signal by the ADC 141 and sampled and a calculation processing on the measurement speed. In addition, while not illustrated in FIG. 2, the calculation circuit 140 includes a storage unit which stores programs and various types of data (for example, a program executing the calculation according to the following Expression (1), an amplitude threshold, etc.) used in the processing of the ADC 141 and the CPU 142. Further, such a storage unit may be configured such that at least a part thereof is included in the external device 11 connected to the speed measurement device 10.

The speed measurement device 10 illustrated in FIG. 2 calculates a magnitude v (hereinafter, referred to as “measurement speed v”) of the speed as follows.

First, the oscillator 115 generates a 77 GHz band radio frequency signal. The radio frequency signal generated by the oscillator 115 is amplified by the transmission amplifier 116, propagated to the antenna 112 through the isolator 117 and the port 113, and emitted from the antenna 112 to the space as the electromagnetic wave (emission electromagnetic wave). The emission electromagnetic wave is focused by the lens 120, and incident and reflected on the ground G. As described with reference to FIG. 1, the electromagnetic wave emitted from the speed measurement device 10 mounted in the vehicle 1 is the electromagnetic wave R1. The electromagnetic wave R1 is propagated in the xz plane, and incident on the ground G (traveling path) at the angle θ.

Then, if the emission electromagnetic wave (the electromagnetic wave R1) is incident on the ground G, the electromagnetic wave is reflected on the ground G. The reflected electromagnetic wave (reflection electromagnetic wave) is incident on the antenna 112 after being focused by the lens 120. Herein, the reflection electromagnetic wave changes a frequency in proportion to the speed of the vehicle 1 with respect to the ground G by the Doppler effect which is generally known.

Next, the reflection electromagnetic wave signal received by the antenna 112 is propagated to the reception amplifier 118 from the port 113 through the isolator 117, and input to the mixer 119 after being amplified by the reception amplifier 118. Further, as also illustrated in the circuit configuration of FIG. 2, the 77 GHz band radio frequency signal output from the oscillator 115 is also input to the mixer 119. Then, the mixer 119 generates the IF signal by mixing both input signals.

Herein, the IF signal generated by the mixer 119 will be described in detail. The IF signal is a signal indicating a difference between the frequency of the signal amplified by the reception amplifier 118 (the electromagnetic wave signal reflected on the ground G) and the frequency of the signal output from the oscillator 115 (the electromagnetic wave signal emitted to the ground G). In other words, the frequency of the IF signal is an absolute value of the change in frequency caused by the Doppler effect.

Then, the magnitude of the change in frequency caused by the Doppler effect (that is, a peak frequency (a frequency f_{d}) of the IF signal generated by the mixer 119 is known as the following Expression (1).

$$\begin{matrix}[ MATH . 1 ] & \\ {f}_{d} = \frac{2 {f}_{0} cos θ}{c} {v}_{x} & ( 1 )\end{matrix}$$

Further, in Expression (1), c represents a light speed, f₀, represents a frequency of the signal output from the oscillator 115, θ represents an angle formed when the electromagnetic wave R1 is incident on the ground G (see FIG. 1), and vₓ represents a speed component in an x direction in FIG. 1 (in FIG. 1, the vehicle 1 is assumed to travel in an x axial direction).

According to Expression (1), if a frequency f₀ and angle θ are determined uniquely, a fraction term ((2f₀·cos θ)/c) on the right side of Expression (1) becomes a constant. Therefore, the frequency f_{d} is proportional to the speed vₓ.

Next, the IF signal generated by the mixer 119 is sent to the IF signal amplifier 130 connected to the millimeter wave radar module 110 and amplified, and input to the calculation circuit 140. In the calculation circuit 140, the AD converter (ADC) 141 converts the IF signal from the analog signal to a digital signal. The CPU 142 performs a fast Fourier transform (FFT) processing and the calculation processing on the measurement speed (the measurement speed v) using the converted digital signal.

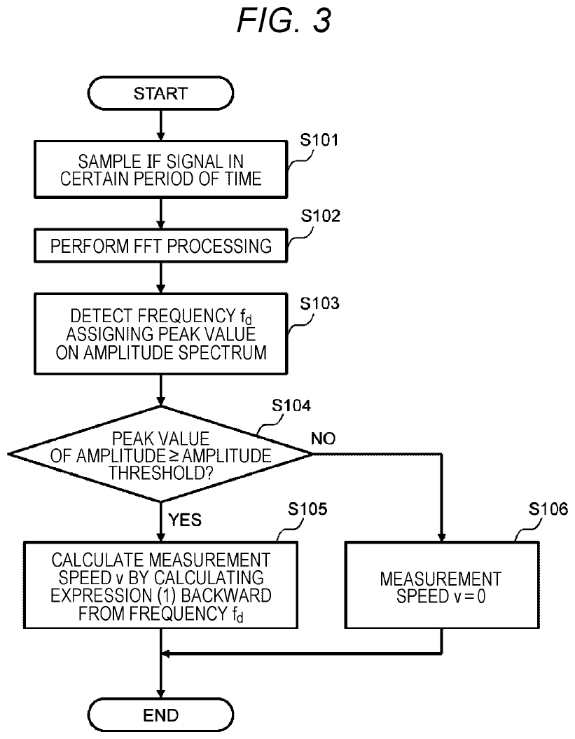

FIG. 3 is a flowchart illustrating a procedure example of a calculation processing of a measurement speed in the speed measurement device. In the speed measurement device 10, the CPU 142 of the calculation circuit 140 performs the processing illustrated in FIG. 3 at every certain time for example to calculate the measurement speed v.

First, the CPU 142 of the calculation circuit 140 samples the IF signal converted into the digital signal by the ADC 141 in a certain period of time, and obtains a waveform of a predetermined time period (step S101). Next, the CPU 142 performs the fast Fourier transformation (FFT) processing on the waveform obtained in step S101, and obtains an amplitude spectrum of the IF signal (step S102).

Next, the CPU 142 obtains a frequency at a peak value of the amplitude spectrum obtained in step S102 as the frequency f_{d} of the IF signal (step S103). Then, in step S104, the CPU 142 determines whether the peak value of the amplitude spectrum is equal to or more than a predetermined amplitude threshold.

In a case where it is determined in step S104 that the peak value of the amplitude spectrum is equal to or more than the predetermined amplitude threshold (YES in step S104), the CPU 142 calculates the measurement speed v from the frequency f_{d} by calculating Expression (1) backward (step S105), and ends the process. On the other hand, in a case where it is determined in step S104 that the peak value of the amplitude spectrum is less than the predetermined amplitude threshold (NO in step S104), the CPU 142 sets the measurement speed v to “0” (step S106), and ends the process.

With the processes of steps S101 to S106 so far, the CPU 142 calculates the measurement speed v. However, the speed measurement device 10 according to this embodiment may perform the following processes as a derivative example of the processing procedure.

For example, in a case where the CPU 142 compares the peak value of the amplitude spectrum and the amplitude threshold in step S104 and determines that the peak value of the amplitude spectrum is larger (or a case where the peak value is equal to or more than the amplitude threshold may be used), the measurement speed v is calculated in the procedure of step S105, and also the calculated measurement speed v may be output to the outside (for example, the external device 11) of the speed measurement device 10.

In addition, the speed measurement device 10 (more specifically, the calculation circuit 140 or the CPU 142) may send the measurement speed v calculated by the CPU 142 in steps S105 and S106 together with the information such as the peak value of the amplitude spectrum to the external device 11. Further, the external device 11 may include a unit which stores the amplitude threshold, and determines the information (for example, the traveling/stopped state, etc.) on the basis of the speed of the vehicle 1 to change the amplitude threshold, so that the amplitude threshold is set in accordance with a situation. In addition, with such a configuration, measurement speed v is employed in a case where the speed measurement device 10 (for example, the CPU 142) compares the peak value of the amplitude spectrum and the amplitude threshold as illustrated in step S104, and determines that the peak value of the amplitude spectrum is larger (or a case where the peak value is equal to or more than the amplitude threshold may be used). The measurement speed may be set to “0” in a case where the peak value of the amplitude spectrum is equal to or less than the amplitude threshold (or a case where the peak value is smaller than the amplitude threshold may be used).

By the way, in the flowchart of FIG. 3, the comparison and determination of step S104 when the measurement speed v is calculated is performed on a condition that the peak value of the amplitude spectrum is equal to or more than the amplitude threshold. However, in such a case, there are problems to be considered as follows.

[First Problem]

In a case where the intensity of the reflection wave is weak depending on the state of the traveling path (the ground G), the peak value of the amplitude spectrum may be lowered to be less than a predetermined amplitude threshold. If comparison and determination of step S104 is performed in such a situation, the process proceeds to step S106, and the measurement speed v is determined as “0”.

[Second Problem]

in the signal component input to the mixer 119, there are a signal component obtained from a path where a frequency signal generated by the oscillator 115 directly input to the mixer 119, and a signal component obtained from a path where a signal is reflected due to a mismatching of the antenna 112 through the isolator 117 and input to the mixer 119 again through the isolator 117. Since there is a difference in length of the path until the two signal components are input, there is caused each time (timing) difference at which the two signal components are input to the mixer 119. Since there is a jitter (a variation component generated in a time axis direction) in the frequency signal generated by the oscillator 115, the frequencies of the signal components input to the mixer 119 are technically not the same because of the time difference of input timing of the two signal components. Therefore, the difference of the two signal components (that is, the jitter component) is output from the mixer 119. Then, such a jitter component appears on the amplitude spectrum after FFT processing, and the peak value of the amplitude spectrum may become equal to or more than a predetermined amplitude threshold. Even in such a case, process is performed from step S104 to step S105 according to FIG. 3, and the measurement speed v is wrongly calculated.

[Third Problem]

For example, the noise of an external electromagnetic wave may be incident the IF signal amplifier 130. The noise component appears on the amplitude spectrum after the FFT processing, and the peak value of the amplitude spectrum may become equal to or more than a predetermined amplitude threshold. Even in such a case, the process is performed from step S104 to step S105 according to FIG. 3, and the measurement speed v is wrongly calculated.

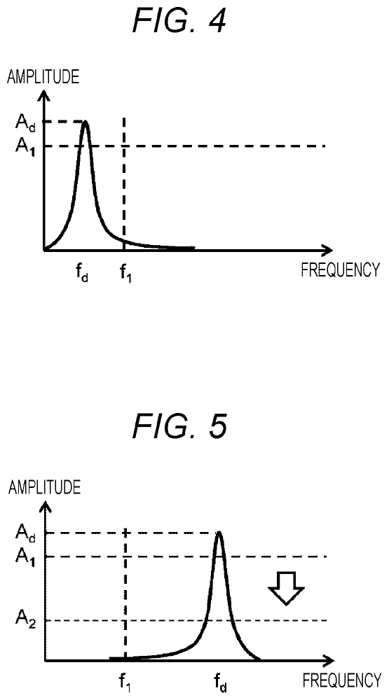

Therefore, in order to cope with such problems, in the speed measurement device 10 according to this embodiment, the amplitude threshold is changed according to the traveling state of the vehicle 1 and the state of the traveling path (the ground G), so that the measurement speed v can be calculated appropriately. In the following, an example of the amplitude spectrum (see step S102 of FIG. 3) of the IF signal obtained by performing the FFT processing by the CPU 142 in the calculation circuit 140 is illustrated in FIGS. 4 to 6. A specific method of calculating the measurement speed v accompanied with the variation of the amplitude threshold will be described with reference to the drawings.

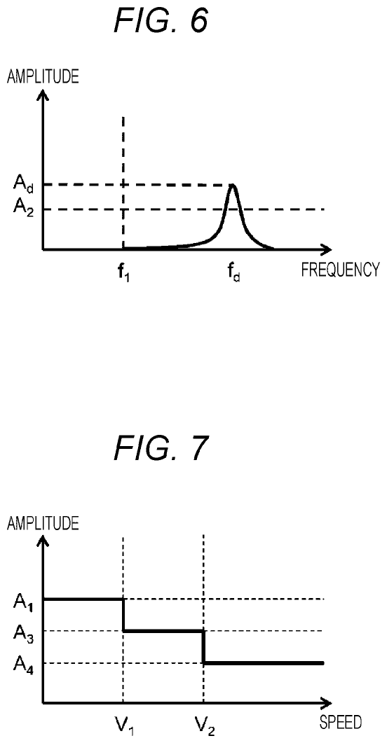

FIG. 4 is a diagram for describing an example of the amplitude spectrum when the vehicle is in a “stopped state”. In FIG. 4, the horizontal axis represents frequency, and the vertical axis represents amplitude value corresponding to each frequency. Further, in the horizontal axis of FIG. 4, the frequency applying the peak value of the amplitude spectrum is the frequency f_{d} of the IF signal. Therefore, the horizontal axis may be considered as equivalent to the axis of the measurement speed with reference to Expression (1). The illustrating method of such a drawing is also applied to the following drawings (for example, FIGS. 5 and 6) similarly, and the description thereof will be omitted.

According to FIG. 4, the amplitude spectrum becomes a peak value A_{d} at the frequency f_{d}, and an amplitude threshold A₁ (the amplitude threshold A₁ of the stopped state) is illustrated as the amplitude threshold when the vehicle 1 is in the “stopped state”. Herein, the “stopped state” related to the traveling state of the vehicle 1 includes an extremely low speed state where the speed is equal to or less than a predetermined boundary speed (specifically, 2 km/h for example) including a state (0 km/h) where the vehicle 1 is completely stopped. Therefore, a time immediately after the completely stopped vehicle 1 starts to travel is considered as in the “stopped state”. Further, since it is not particularly desirable that the measurement speed v is wrongly calculated due to noises input when the vehicle is in the “stopped state”, the amplitude threshold A₁ of the stopped state is desirably set to a value larger than the other amplitude thresholds described below.

In addition, the frequency f₁ illustrated in FIG. 4 is a frequency derived from the predetermined boundary speed. Specifically, for example, the frequency can be calculated by setting vₓ in Expression (1) as the boundary speed. Hereinafter, the frequency derived from such a boundary speed will be called a “frequency corresponding to the boundary speed”. Then, in the case of the amplitude spectrum of FIG. 4, the frequency f_{d} assigned with the peak value A_{d} is smaller than the frequency f₁ corresponding to the boundary speed, which indicates that the speed of the vehicle 1 is the stopped state at a speed lower than the boundary speed.

Then, in the case of FIG. 4, the peak value A_{d} of the amplitude spectrum is equal to or more than the amplitude threshold A₁ of the stopped state. Therefore, the CPU 142 calculates the measurement speed v from the frequency f_{d} assigned with the peak value A_{d} using Expression (1) as described in step S105 of FIG. 3.

FIG. 5 is a diagram for describing an example of the amplitude spectrum when the vehicle is in a “traveling state”. Further, the “traveling state” related to the vehicle 1 means a situation where vehicle 1 enters the “stopped state” (including immediately after starting the traveling) illustrated in FIG. 4 and is accelerated up to a predetermined boundary speed (for example, 2 km/h). In the case of the amplitude spectrum illustrated in FIG. 5, the frequency f_{d} assigned with the peak value A_{d} is larger than the frequency f₁ corresponding to the boundary speed. Therefore, it is predicted that the speed of the vehicle 1 is in the traveling state exceeding the boundary speed.

In the case of FIG. 5, since the peak value A_{d} of the amplitude spectrum is equal to or more than the amplitude threshold A₁ of the stopped state, the CPU 142 calculates first the measurement speed v using Expression (1) as described above in step S105 of FIG. 3.

Further, in the case of FIG. 5, it is determined that the measurement speed v calculated by the CPU 142 is equal to or more than the boundary speed. Therefore, the amplitude threshold in the next speed measurement timing is changed. Specifically, as illustrated in FIG. 5, “the amplitude threshold A₁ of the stopped state” is changed to “an amplitude threshold A₂ of the traveling state”, and at this time the amplitude threshold becomes small. On the contrary, when “the amplitude threshold A₂ of the traveling state” is selected as the traveling state of the vehicle 1, and in a case where it is determined that the measurement speed v calculated by the CPU 142 is less than the boundary speed, the vehicle 1 is predicted to be shifted to the stopped state. The CPU 142 may change the amplitude threshold at the next speed measurement timing from “the amplitude threshold A₂ of the traveling state” to “the amplitude threshold A₁ of the stopped state”. At this time, the amplitude threshold becomes large.

FIG. 6 is a diagram for describing an example of the amplitude spectrum in a case where the vehicle is in the “traveling state” and the intensity of the reflection wave is weak due to the state of the traveling path. In a case where the state of the traveling path (the ground G) is bad, the intensity of the reflection wave of the electromagnetic wave R1 emitted from the speed measurement device 10 may become weaker than the usual one. 6 illustrates an example of the amplitude spectrum of the IF signal obtained in such a case.

According to the amplitude spectrum illustrated in FIG. 6 the peak value A_{d} of the amplitude spectrum is smaller than the peak value A_{d} of the amplitude spectrum illustrated in FIG. 5, and larger than the amplitude threshold A₂ of the traveling state.

Herein, when the peak value A_{d} of the amplitude spectrum and the amplitude threshold A₁ of the stopped state are compared as illustrated in FIG. 5 in the comparison and determination in step S104 of FIG. 3, there is a concern that the measurement speed v becomes “0”, and an appropriate speed calculation is not possible. However, as described above with reference to FIG. 5, at timing after the measurement speed v is calculated in the traveling state, the amplitude threshold is changed to amplitude threshold A₂ of the traveling state. Therefore, the CPU 142 can calculate the measurement speed v from the frequency f_{d} assigned with the peak value A_{d}.

As described above, the speed measurement device 10 according to this embodiment can calculate the measurement speed v even in a case where the intensity of the reflection wave is weak in the state of the traveling path and the state of the system (the vehicle 1 where the speed measurement device 10 is mounted) while preventing an erroneous detection of the measurement speed v due to an influence of the jitter and the external electromagnetic wave noises. Further, in a case where the state of the traveling path is bad, the intensity of the reflection wave detected by the system is weak due to the state of the traveling path. The possibility of the speed measurement device 10 to calculate the measurement speed becomes worse. Therefore, it can be analyzed that “the state of the system” in a broad sense includes “the state of the traveling path”. In addition, in a case where the speed measurement device 10 starts measuring during a period when the vehicle 1 is traveling (for example, a case where the speed measurement device 10 is energized during the traveling), the erroneous detection of the measurement speed v caused by the influence of the jitter and the external electromagnetic wave noise can be removed, and the measurement speed v can be calculated appropriately.

Further, in the above description, the speed measurement device 10 changes the amplitude threshold at the next speed measurement timing in a case where the measurement speed v is higher than the boundary speed (see FIG. 5). However, the speed measurement device 10 according to this embodiment may change the amplitude threshold at the next speed measurement timing in a case where the vehicle 1 moves from the traveling state to the stopped state (that is, the measurement speed v becomes lower than the boundary speed (specifically, for example, changing from the amplitude threshold A₂ of the traveling state to the amplitude threshold A₁ of the stopped state). These configurations may be combined.

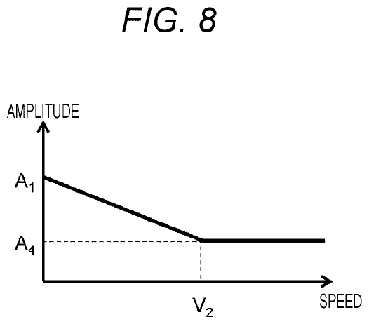

In addition, one boundary speed is set in FIGS. 4 to 6. However, a plurality of boundary speeds may be provided in the speed measurement device 10 according to this embodiment, or the boundary speeds may be continuously provided to calculate the measurement speed v. With such a configuration, in the comparison and determination in step S104 of FIG. 3, the determination can be made in more detail according to the state of the traveling path, and it can be expected that an appropriate measurement speed v can be calculated. Hereinafter, a setting example of the boundary speed will be described in detail with reference to FIGS. 7 and 8.

FIG. 7 is a diagram (Part 1) for describing a relation between the boundary speed and the amplitude threshold. FIG. 7 illustrates a relation example in a case where two boundary speeds (boundary speeds V₁ and V₂) are provided.

Specifically, according to FIG. 7, if the speed of the vehicle 1 is between zero and the boundary speed V₁, “the amplitude threshold A₁ of the stopped state” is employed as the amplitude threshold at the next speed measurement timing. Then, if the speed of the vehicle 1 is between the boundary speed V, and the boundary speed V₂, “an amplitude threshold A of the low speed state” is employed as the amplitude threshold at the next speed measurement timing. In addition, if the speed of vehicle 1 is equal to or more than the boundary speed V₂, “an amplitude threshold A₄ of the high speed state” is employed as the amplitude threshold at the next speed measurement timing. With such a configuration, the amplitude threshold is made small in plural stages as the speed of the vehicle 1 is increased, so that the measurement speed v can be calculated.

FIG. 8 is a diagram (Part 2) for describing a relation between the boundary speed and the amplitude threshold. FIG. 8 illustrates a relation example in a case where the continuous boundary speeds are provided.

Specifically, according to FIG. 8, a value continuously reduced between “the amplitude threshold A₁ of the stopped state” and “the amplitude threshold A₄ of the high speed state” as the amplitude threshold at the next speed timing is employed when the speed of the vehicle 1 is between zero and the boundary speed V₂. However, if the speed of the vehicle 1 is equal to or more than the boundary speed V₂, “an amplitude threshold A₄ of the high speed state” is employed as the amplitude threshold at the next speed measurement timing. With such a configuration, a dynamic amplitude threshold which is reduced until the speed of the vehicle 1 reaches a predetermined level (zero to the boundary speed V₂) is employed to calculate the measurement speed v. After the speed of the vehicle 1 reaches a predetermined level, a static amplitude threshold A₄ is employed to calculate the measurement speed v while avoiding that the amplitude threshold finally becomes “0”.

Hitherto, in a case where the boundary speed (a reference of changing the amplitude threshold) is provided by two or more, the speed measurement device 10 according to this embodiment can remove the erroneous detection of the measurement speed caused by the influence of the jitter and the external electromagnetic wave noise and calculate the measurement speed v more finely than the method illustrated in FIGS. 4 to 6 in an appropriate manner according to the speed of the vehicle 1.

In addition, the speed measurement device 10 according to this embodiment may be provided with the following derivatives. Even in a case where such derivatives are provided, the speed measurement device 10 can obtain the effects similar to those described above.

[First Derivative]

The speed measurement device 10 includes a unit which compares the amplitude of the IF signal and the amplitude threshold, determines whether to calculate the measurement speed, determines a state on the basis of the speed in the traveling state/the stopped state of the vehicle 1 to change the amplitude threshold.

[Second Derivative]

The speed measurement device 10 includes a unit which switches to a process of changing the amplitude threshold, and multiplies a coefficient (for example, a coefficient corresponding to a reciprocal of the amplitude threshold) on the basis of the speed of the traveling state/the stopped state of the vehicle 1 in process of transmitting to receiving the millimeter wave or in the waveform processing.

Making an explanation of the unit in detail, there is a considered a unit which changes an intensity of emitting the signal generated by the oscillator 115 as a first example. This example can be realized by changing a gain of the transmission amplifier 116 illustrated in FIG. 2 for example.

In addition, as a second example, there is considered a unit which changes a gain of the signal of the reflection wave from the ground G. This example can be realized by changing a gain of the reception amplifier 118 illustrated in FIG. 2 for example.

In addition, as a third example, there is considered a unit which changes a gain of the IF signal. This example can be realized by changing a gain of the IF signal amplifier 130 for example, and can be realized by multiplying a coefficient to a waveform obtained by sampling the IF signal converted into the digital signal by the CPU 142 of the calculation circuit 140 or an amplitude spectrum obtained by performing the FFT processing on the waveform.

### (2) Second Embodiment

The speed measurement device according to a second embodiment of the invention will be described.

The speed measurement device according to the second embodiment performs a determining process (a determining process of the amplitude threshold) different from that of the speed measurement device of the first embodiment on the amplitude threshold used in comparing and determining a magnitude with the peak value of the amplitude spectrum of the IF signal. Therefore, the process other than the determining process of the amplitude threshold (specifically, the calculating process of the measurement speed v illustrated in FIG. 3) is executed similarly to the first embodiment, and the detailed description will be omitted. In addition, the speed measurement device 10 used in the first embodiment can be employed in a physical configuration of the speed measurement device according to the second embodiment, and the second embodiment will be described using the speed measurement device 10.

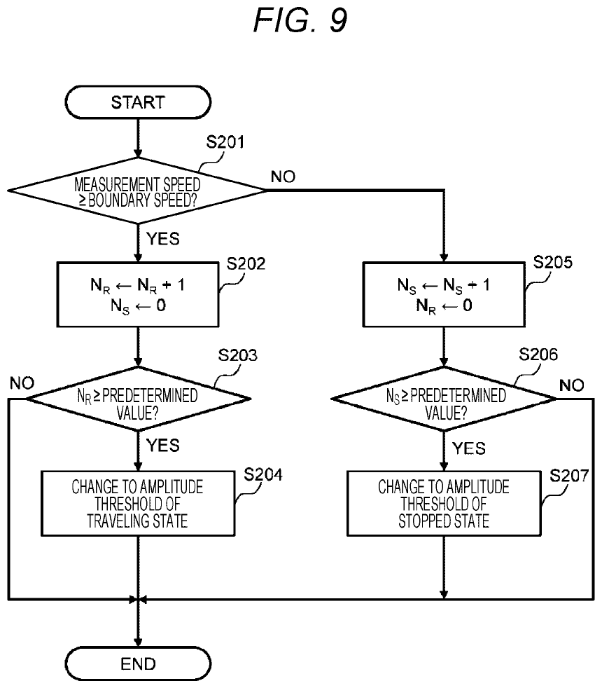

FIG. 9 is a flowchart illustrating a procedure example of the determining process of the amplitude threshold in the second embodiment. A series of processes illustrated in FIG. 9 is performed by the CPU 142 at every time when the calculating process of the measurement speed v illustrated in FIG. 3 is ended.

In FIG. 9, N_{R} and N_{S} represent variables indicating number of times of repetitions for each determining result in the determining process (described below in detail) of step S201, and an initial value is set to “0”. More specifically, N_{R} indicates the number of times of repetitions in a case where the measurement speed v is equal to or more than the boundary speed and the number of times of repetitions in a case where the measurement speed is less than the boundary speed, and N_{S} indicates the number of times of repetitions in a case where the measurement speed v is less than the boundary speed.

In addition, the measurement speed v on an initial condition at the time of initial starting of the process illustrated in FIG. 9 is calculated by the calculating process (FIG. 3) of the measurement speed. However, in step S104 of the calculating process, the magnitudes of the peak value A_{d} of the amplitude spectrum of the IF signal and “the amplitude threshold of the stopped state (for example, corresponding to the amplitude threshold A₁ illustrated in FIG. 4)” are compared. Therefore, the amplitude threshold selected at the time of initial starting of the process illustrated in FIG. 9 becomes the amplitude threshold A₁ of the stopped state. Then, in a case where the amplitude threshold is changed after the process illustrated in FIG. 9, the calculating process (FIG. 3) of the next measurement speed is performed using the changed amplitude threshold.

Making an explanation of the determining process of the amplitude threshold illustrated in FIG. 9 in detail, first, the CPU 142 determines whether the measurement speed v calculated by the calculating process of the measurement speed is equal to or more than the boundary speed (step S201). In a case where the measurement speed v is determined to be equal to or more than the boundary speed (YES of step S201), the process proceeds to step S202. In a case where the measurement speed is determined to be less than the boundary speed (NO of step S201), the process proceeds to step S205. Further, in this example, the boundary speed is described as one predetermined value. However, in a case where the changeable boundary speeds of the multiple stages are prepared as described in the first embodiment, a boundary speed selected at the corresponding time point may be used.

In a case where the process progresses from step S201 to step S202, the CPU 142 adds “1” to N_{R}, and clears N_{S} to zero. Next, the CPU 142 determines whether N_{R} with the addition in step S202 reaches a predetermined value (that is, whether N_{R} is equal to or more than a predetermined value) (step S203).

In a case where it is determined in step S203 that N₃ is equal to or more than the predetermined value (YES of step S203), the CPU 142 changes the amplitude threshold to “the amplitude threshold of the traveling state (for example, corresponding to the amplitude threshold A₂ illustrated in FIG. 5)” (step S204), and the process ends. In a case where it is determined in step S203 that N₃ is less than the predetermined value (NO of step S203), the CPU 142 ends the process as it is.

On the other hand, in a case where the process progresses from step S201 to step S205, the CPU 142 adds “1” to N_{S}, and clears N_{R} to zero. Next, the CPU 142 determines whether N_{S} with the addition in step S205 reaches a predetermined value (that is, whether N_{S} is equal to or more than the predetermined value) (step S206).

In a case where it is determined in step S206 that N_{S} is equal to or more than the predetermined value (YES of step S206), the CPU 142 changes the amplitude threshold to “the amplitude threshold of the stopped state (for example, the amplitude threshold A₁)” (step S207), and the process ends. In a case where it is determined in step S206 that N_{S} is less than the predetermined value (NO of step S206), the CPU 142 ends the process as it is.

Hitherto, with the determining process of the amplitude threshold illustrated in FIG. 9, the speed measurement device 10 according to this embodiment can have a hysteresis characteristic with respect to the changing of the amplitude threshold. Thus, according to the speed measurement device 10, even if the peak value of the amplitude spectrum of the IF signal is increased more than the amplitude threshold due to the influence of the jitter and the external electromagnetic wave noise which occur with a high intensity at the time of stopping the vehicle 1 so as to erroneously detect the measurement speed the amplitude threshold is suppressed from being changed small immediately thereafter (see the process from YES of step S201 to NO of step S203 in FIG. 9), so that it is possible to reduce the possibility to cause the erroneous detection to be generated continuously. In addition, the amplitude threshold is not immediately changed to be high on a condition equal to or less than the boundary speed before the vehicle 1 stops (see the process from NO of step S201 to NO of step 206 in FIG. 9), so that it is possible to increase the possibility that the measurement speed v is calculated immediately before the stopping.

### (3) Third Embodiment

The speed measurement device according to a third embodiment of the invention will be described.

The speed measurement device according to the third embodiment changes the amplitude threshold used in comparing and determining a magnitude with the peak value of the amplitude spectrum of the IF signal in consideration of the mixed jitter component and the traveling speed of the speed measurement device (or the vehicle where the speed measurement device is mounted). The speed measurement device 10 used in the first embodiment can be employed in a physical configuration of the speed measurement device according to the third embodiment, and the third embodiment will be described using the speed measurement device 10.

In the speed measurement device 10, if the traveling speed of the speed measurement device 10 (that is, the traveling speed of the vehicle 1 where the speed measurement device 10 is mounted) is increased, the amplitude spectrum of the IF signal obtained through the FFT processing of the ADC 141 of the calculation circuit 140 is widened on a frequency axis, and the peak value is lowered. First, the background of such a characteristic will be described.

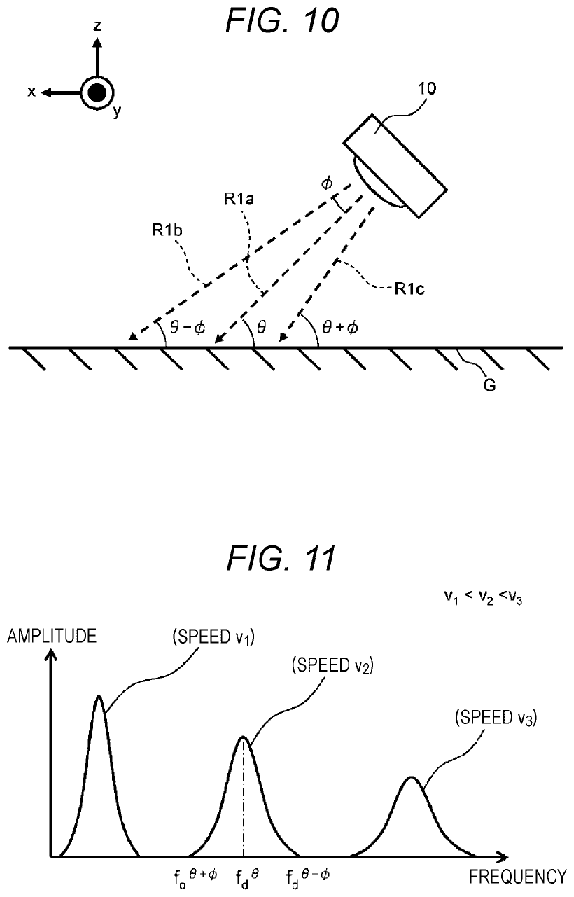

FIG. 10 is a diagram for describing an irradiation range of an electromagnetic wave which is emitted from the speed measurement device. In FIG. 10, a component which is incident at the angle θ with respect to the ground G in the center axial direction in the electromagnetic wave emitted from the speed measurement device 10 (the electromagnetic wave R1 in FIG. 1) is set to an electromagnetic wave R1a. Herein, as illustrated in FIG. 10, the electromagnetic wave is emitted from the speed measurement device 10 within a range of the irradiation range of the ground G. If a maximum value of the angle deviating from the center axial direction is set to 0, a ran between the incident angle (θ−Φ) and the incident angle (θ+Φ) with respect to the ground G is the irradiation range. The component of the electromagnetic wave incident on the ground G at the incident angle (θ−Φ) is set to an electromagnetic wave Rib, and the component of the electromagnetic wave incident on the ground G at the incident angle (θ+Φ) is set to an electromagnetic wave R1c.

The intensity of the electromagnetic wave R1 emitted from the speed measurement device 10 is largest in the center axial direction (the electromagnetic wave R1a), and is lowered as it goes away from the center axial direction (the electromagnetic waves R1b and R1c). Then, the peak frequencies (a frequency f_{d}^{θ-Φ} and a frequency f_{d}^{θ+Φ}) of the IF signal generated by the mixer 119 with respect to the electromagnetic waves R1b and R1c are defined as the following Expressions (2) and (3) by replacing the incident angle of Expression (1).

$$\begin{matrix}[ MATH . 2 ] & \\ {f}_{d}^{θ - φ} = \frac{2 {f}_{0} cos ( θ - φ )}{c} {v}_{x} & ( 2 ) \\ [ MATH . 3 ] & \\ {f}_{d}^{θ + φ} = \frac{2 {f}_{0} cos ( θ + φ )}{c} {v}_{x} & ( 3 )\end{matrix}$$

In other words, the amplitude spectrum after the FFT processing in the emission of the electromagnetic wave R1 is widened to the range from the frequency f_{d}^{θ-Φ} to the frequency f_{d}^{θ+Φ} about a frequency f_{d}^{θ} (the superscript means the frequency of the IF signal in the direction of the angle θ).

Herein, if a reflection intensity of the electromagnetic wave R1 from the ground G is constant in a place (the state of the traveling path) or regardless of places, a total sum of energy of the amplitude spectrum (that is, the area) becomes constant regardless of the speed. In other words, if the speed is high, the amplitude spectrum is widened on the frequency axis, and the peak value becomes lowered.

FIG. 11 is a diagram illustrating an example of the amplitude spectrum after the FFT processing. FIG. 11 illustrates the amplitude spectrum after the FFT processing with respect to different measurement speeds v₂, and v₃ (v₁<v₂<v₃). As described in the previous paragraphs, the frequency f_{d}^{θ} assigning the peak value of the amplitude spectrum (and the frequencies f_{d}^{θ-Φ} and f_{d}^{θ+Φ}) is increased as the measurement speed v is increased, and the peak value is lowered.

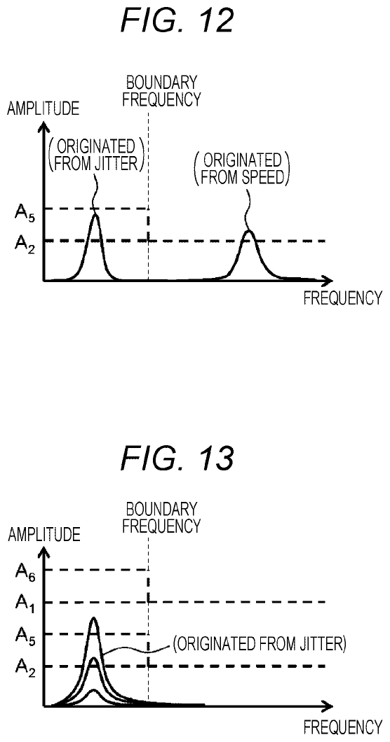

FIG. 12 is a diagram for describing an example of the amplitude spectrum in a case where there is the jitter in the traveling state. FIG. 12 illustrates the amplitude spectrum containing the jitter component. The jitter contains a lot of low frequency components, and the amplitude spectrum originated from the jitter tends to change with time. Therefore, as illustrated in FIG. 12, the peak value of the amplitude spectrum originated from the jitter may be larger than the peak value of the amplitude spectrum of a Doppler signal originated from a speed.

In the above case, if the peak value of the amplitude spectrum originated from the jitter is employed as the peak value of the amplitude spectrum to calculate the measurement speed v, there is a concern that an appropriate speed is not calculated. Therefore, in the example of FIG. 12, a predetermined boundary frequency is provided. On a low frequency side of the boundary frequency, the amplitude threshold is set relatively high (for example, the amplitude threshold A₅). On a radio frequency side of the boundary frequency, the amplitude threshold is set relatively low (for example, the amplitude threshold A₂).

Then, the speed measurement device 10 according to this embodiment changes the amplitude threshold using the boundary frequency as illustrated in FIG. 12, so that it is possible to determine that only the peak value of the amplitude spectrum originated from the speed component is equal to or more than the amplitude threshold particularly in a case where the speed of the vehicle 1 is high, and the measurement speed v can be appropriately calculated.

Next, FIG. 13 is a diagram for describing an example of the amplitude spectrum in a case where the intensity of the jitter is strong in the stopped state. FIG. 13 illustrates a plurality of amplitude spectrums showing the variation of the jitter component which varies with time. In addition, FIG. 13 illustrates the amplitude threshold A₂ at the time of the radio frequency and an amplitude threshold A₅ at the time of low frequency as the amplitude threshold in the traveling state, which are the same as described in FIG. 12.

Then, in addition to two types of the amplitude thresholds in the traveling state, FIG. 13 illustrates two types of the amplitude thresholds (the amplitude threshold A₁ and an amplitude threshold A₆) in the stopped state. The amplitude threshold A₁ is an amplitude threshold on the radio frequency side of the predetermined boundary frequency in the stopped state. The amplitude threshold A₆ is an amplitude threshold on the low frequency side of a predetermined boundary frequency in the stopped state.

In FIG. 13, the frequency assigning the highest peak value of the amplitude spectrum is on the low frequency side of the boundary frequency, but the peak value is higher than amplitude threshold A₅ on the low frequency side in the traveling state. In such a case, if the amplitude threshold changeable on the basis of the boundary frequency is only prepared for the traveling state, the measurement speed v may be calculated on the basis of the frequency of which the peak value is increased by the influence of the jitter component, and thus an appropriate speed may be not calculated. Therefore, as illustrated in FIG. 13, the amplitude threshold changeable on the basis of the boundary frequency is prepared even for the stopped state, so that it is possible to prevent that the jitter is erroneously calculated as a speed. Specifically, in the case of FIG. 13, the peak value of the amplitude spectrum does not exceed the amplitude threshold A6 on the low frequency side in the stopped state. At this time, the measurement speed v is determines as “0” (see step S106 of FIG. 3).

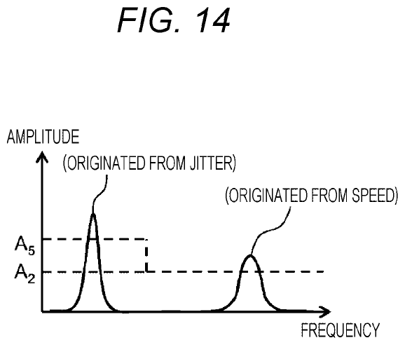

Next, FIG. 14 is a diagram for describing an example of the amplitude spectrum in a case where the intensity of the jitter is strong in the traveling state. Similarly to the configuration described in FIG. 12, FIG. 14 illustrates the amplitude threshold which is changeable on the basis of the boundary frequency in the traveling state (the amplitude threshold A₂ and the amplitude threshold A₅). In the case of the amplitude spectrum illustrated in FIG. 14, both the peak value of the jitter component and the peak value of the Doppler signal originated from a speed become larger than the corresponding amplitude thresholds. In such a case, the CPU 142 may determine any one of the peak values to be used in the comparison and determination for the calculating process of the measurement speed v. Specifically, the CPU 142 desirably selects a radio frequency component as the peak value to calculate measurement speed v using the frequency assigning the employed peak value. If the CPU 142 selects the peak value of the radio frequency component, it is possible to prevent that the speed is erroneously calculated on the basis of the peak value of the jitter component.

Hitherto, the method of changing the amplitude threshold on the basis of the frequency has been described with reference to FIGS. 10 to 14 with respect to the third embodiment in which the amplitude threshold is changed in consideration of the mixed jitter component and the traveling speed of the speed measurement device (or the vehicle where the speed measurement device is mounted). Instead of changing the amplitude threshold on the basis of the frequency, the speed measurement device 10 according to this embodiment may employ a method of applying a high-pass filter for the IF signal before the IF signal is input to the calculation circuit 140 or a method of multiplying a coefficient to each amplitude of each frequency obtained by the amplitude spectrum (specifically, for example, a coefficient corresponding to a reciprocal of the amplitude threshold is multiplied, or a coefficient smaller than the radio frequency component is multiplied to a low frequency component). In this way, even if the waveform itself of the IF signal is corrected, the effect similar to that of the method of changing the amplitude threshold can be achieved.

In addition, an angle φ is increased or the angle θ is decreased in order to widen the irradiation range (irradiation area) of the electromagnetic wave R1 toward the ground G in FIG. 10. However, as can be seen with reference to FIG. 11, if φ is increased, the amplitude spectrum is widened in the frequency axial direction, and the peak value is decreased. Therefore, the angle θ is desirably decreased when the irradiation range (irradiation area) of the electromagnetic wave R1 toward the ground G is widened. However, if the angle θ is excessively decreased, a lower limit of the angle θ is desirably set to about 30 degrees in consideration of that the propagation distance of the electromagnetic wave becomes long (for example, in the case of 8=0, the propagation distance becomes infinity).

### (4) Fourth Embodiment

A fourth embodiment of the invention will be described. In the following description, the same or common elements as those of the speed measurement device 10 according to the first embodiment will be attached with the same symbol, and the description thereof will be omitted.

In the first to third embodiments, the measurement speed v calculated by one speed measurement device 10 has been used as the condition used for determining whether the amplitude threshold is changed, but the invention is not limited thereto.

In the fourth embodiment, the measurement speeds calculated or detected by a plurality of speed measuring units are used for the measurement speed as a condition used in determining whether to change the amplitude threshold. In following, several examples will be described specifically. Further, if not specified otherwise, the other process not related to the change of the amplitude threshold (for example, the calculating process of the measurement speed illustrated in FIG. 3) will be described using the process in the above embodiment.

### First Example

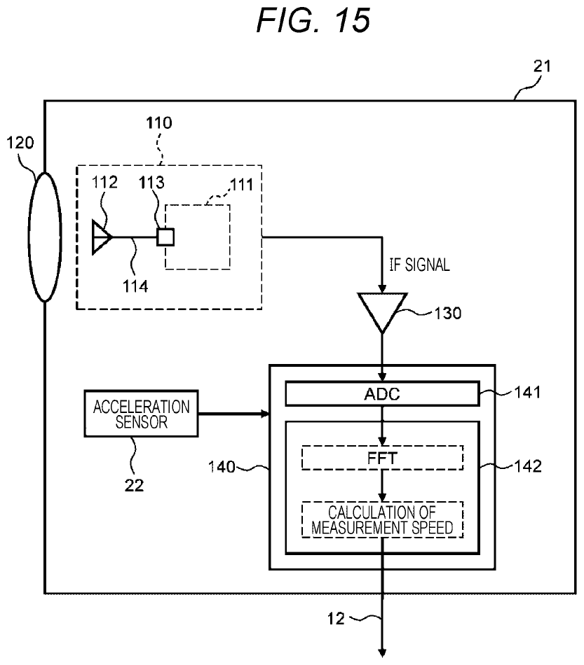

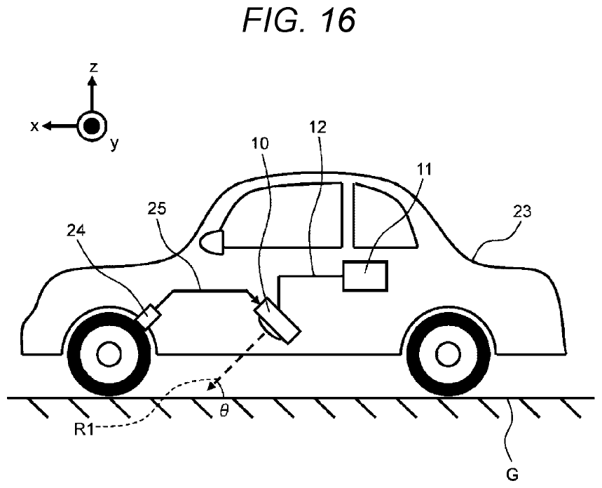

FIG. 15 is a diagram (Part 1) illustrating a configuration example of the speed measurement device according to the fourth embodiment. A speed measurement device 21 illustrated in FIG. 15 is configured by an acceleration detection unit (specifically, an acceleration sensor 22) in addition to the configurations of the speed measurement device 10 illustrated in FIG. 2. The acceleration sensor 22 is a device which measures an acceleration of the speed measurement device 21, and an acceleration sensor can be usually used. The acceleration measured by the acceleration sensor 22 is input to the calculation circuit 140.

In the speed measurement device 21, for example, in a case where there is a change in the acceleration measured by the acceleration sensor 22 when it is determined that the vehicle where the speed measurement device 21 is mounted is in the stopped state, the CPU 142 determines that the vehicle where the speed measurement device 21 is mounted starts traveling, and changes the amplitude threshold to an amplitude threshold for the traveling state. With the acceleration sensor 22 (acceleration detection unit), the traveling state of the vehicle where the speed measurement device 21 is mounted can be grasped more accurately. The speed measurement device 21 can measure an appropriate speed on the basis of the traveling state of the vehicle.

### Second Example

FIG. 16 is a diagram (Part 1) illustrating an example of the vehicle according to the fourth embodiment. A vehicle 23 illustrated in FIG. 16 is configured by a rotation speed detection unit (for example, a rotation speed detection sensor 24) which detects a rotation speed of a tire of the vehicle 23 in addition to the configurations of the vehicle 1 illustrated in FIG. 1. The rotation speed detection sensor 24 and the speed measurement device 10 are connected by a communication line 25. A signal indicating the rotation speed detected by the rotation speed detection sensor 24 is transferred to the speed measurement device 10 through the communication line 25.

In the vehicle 23, the CPU 142 of the speed measurement device 10 changes the amplitude threshold on the basis of the speed detected by the rotation speed detection sensor 24 (rotation speed detection unit). Therefore, the speed measurement device 10 can measure an appropriate speed on the basis of the traveling state of the vehicle.

### Third Example

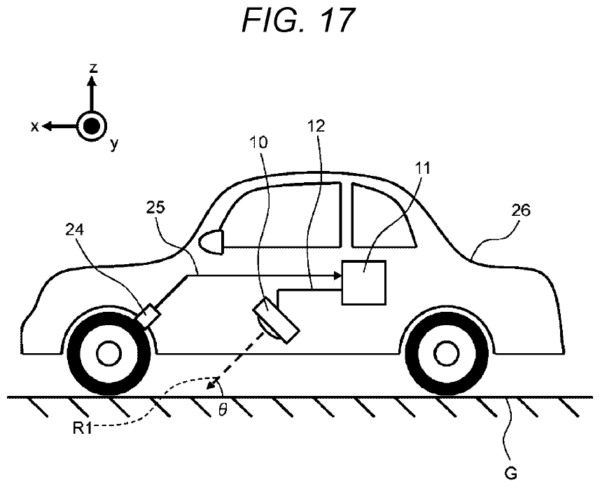

FIG. 17 is a diagram (Part 2) illustrating an example of the vehicle according to the fourth embodiment. A vehicle 26 illustrated in FIG. 17 is different from the vehicle 23 illustrated in FIG. 16 in that that the rotation speed detection sensor 24 and the external device 11 are connected by the communication line 25, and a signal indicating the rotation speed detected by the rotation speed detection sensor 24 is transferred to the external device 11 through the communication line 25.

The vehicle 26 performs the following processes for example. First, if a signal indicating the rotation speed of a tire of the vehicle 26 detected by the rotation speed detection sensor 24 is received, the external device 11 determines whether the vehicle 26 is in the traveling state or the stopped state on the basis of the rotation speed (or the speed of the vehicle 26 derived from the rotation speed). Next, the external device 11 transmits the determination result to the speed measurement device 10 through the communication line 12. Then, in the speed measurement device 10, the CPU 142 changes the amplitude threshold on the basis of the determination result of the traveling state of the vehicle 26 transmitted from the external device 11.

According to the vehicle 26, the external device 11 determines the traveling state of the vehicle 26 on the basis of the speed detected by the rotation speed detection sensor 24 (rotation speed detection unit), and the CPU 142 of the speed measurement device 10 changes the amplitude threshold according to the determination. Therefore, the speed measurement device can measure an appropriate speed on the basis of the traveling state of the vehicle.

### Fourth Example

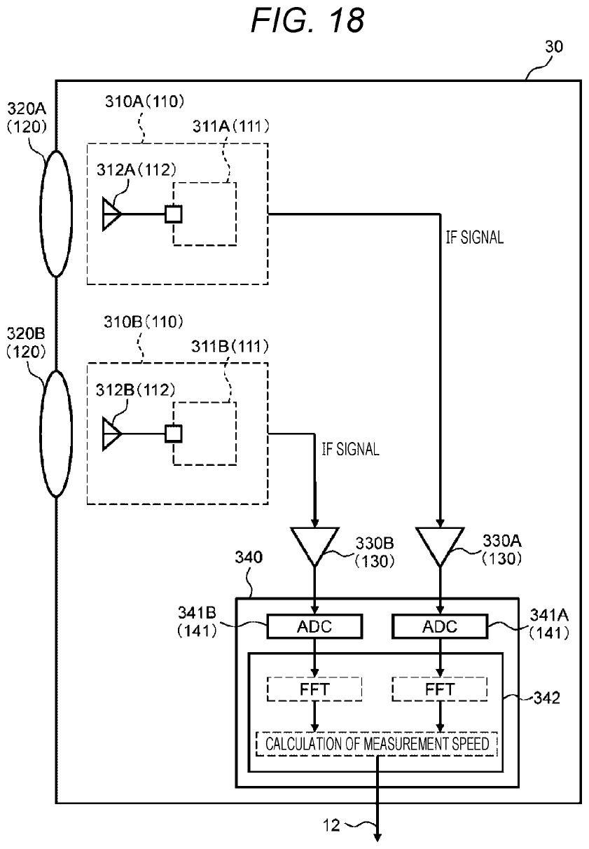

FIG. 18 is a diagram (Part 2) illustrating a configuration example of the speed measurement device according to the fourth embodiment. A speed measurement device 30 illustrated in FIG. 18 includes the millimeter wave radar module 110, the lens 120, and the IF signal amplifier 130 illustrated in FIG. 2 two by two.

Specifically, the speed measurement device 30 includes millimeter wave radar modules 310A and 310B, lenses 320A and 320B respectively corresponding to the millimeter wave radar modules 310A and 310B, IF signal amplifiers 330A and 330B which amplify the IF signals generated by the millimeter wave radar modules 310A and 310B, and a calculation circuit 340 to which the IF signals amplified by the IF signal amplifiers 330A and 330B are input. Further, the configurations (for example, IC chips 311A and 311B and antennas 312A and 312B illustrated in FIG. 18) and the functions of the millimeter wave radar modules 310A and 310B are common components to the millimeter wave radar module 110 illustrated in FIG. 2. Similarly, the lenses 320A and 320B are common components to the lens 120 illustrated in FIG. 2. The IF signal amplifiers 330A and 330B are common components to the IF signal amplifier 130 illustrated in FIG. 2. Therefore, the redundant description of these configurations will be omitted.

In the speed measurement device 30, the calculation circuit 340 includes AD converters (ADC) 341A and 341B and a CPU 342 to process the IF signal output from the millimeter wave radar modules 310A and 310B through the IF signal amplifiers 330A and 330B. The AD converters (ADC) 341A and 341B convert the received analog IF signals into digital signals, so that the common component to the ADC 141 illustrated in FIG. 2 can be used. The CPU 342 performs the fast Fourier transformation (FFT) processing on the sampled IF signals which are the digital signals converted by the two ADCs 341A and 341B, and performs the calculating process of the measurement speed using the amplitude spectrum of the IF signal after the FFT processing.

In the speed measurement device 30 configured as described above, there may occur a difference in intensity of the reflection wave by a difference in irradiation position on the around G of the electromagnetic waves which are emitted by the millimeter wave radar module 310A and the millimeter wave radar module 310B. In such a case, the measurement speed can be calculated only from the IF signal obtained from any one of the millimeter wave radar modules 310A and 310B.

Specifically, for example, it is assumed a case where the CPU 342 calculates a measurement speed v₁ from the IF signal of the millimeter wave radar module 310A, but the CPU 342 does not calculate a measurement speed v₂ because the intensity of the reflection wave of the IF signal of the millimeter wave radar module 310B from the ground G is weak (the measurement speed v₂ becomes “0”).

At this time, in the speed measurement device 30, the CPU 342 obtains information indicating that the measurement speed v is calculated from the IF signal of the millimeter wave radar module 310A and estimates that the vehicle where the speed measurement device 30 is mounted is traveling. Therefore, the CPU 342 changes the amplitude threshold used in the calculating process of the measurement speed v₂ based on the IF signal of the millimeter wave radar module 310B to be small. Then, if the CPU 342 performs the calculating process of the measurement speed v₂ based on the IF signal of the millimeter wave radar module 310B after changing the amplitude threshold to be small, the peak value is more likely to become equal to or more than the amplitude threshold after being changed in the comparison and determination (step S104 of FIG. 3) between the peak value of the amplitude spectrum of the IF signal and the amplitude threshold, and the measurement speed v₂ is also expected to be calculated.

Further, when the CPU 342 changes the amplitude threshold used in the calculating process of the measurement speed from the IF signal on the basis of the information indicating that the measurement speed is calculated from the other IF signal, a timing when the calculating process of the measurement speed using the changed amplitude threshold is not particularly limited. For example, as described above, in a case where the measurement speed v₁ is calculated from the IF signal of the millimeter wave radar module 310A, but the measurement speed v₂ is not calculated from the IF signal of the millimeter wave radar module 310B, the calculating process of the measurement speed v₂ may be performed again after changing the amplitude threshold to be small, or a small amplitude threshold obtained from the next calculating process of the measurement speed v₂ may be used.

In addition, the speed measurement device 30 in this example may include three or more millimeter wave radar modules and the configurations corresponding to these millimeter wave radar modules. In the case of such a configuration, the CPU 342 may appropriately change the amplitude threshold used in the calculating process of the measurement speed using the IF signal of each millimeter wave radar module on the basis of the information indicating whether the measurement speed is calculated from the IF signal obtained by each millimeter wave radar module (whether the measurement speed other than “0” is obtained).

In any case, according to the speed measurement device 30 described above, in a case where the measurement speed is calculated on the basis of the IF signal obtained by each of the plurality of the millimeter wave radar modules and there is partially an IF signal with which the measurement speed is not calculated because of a weak intensity of the reflection wave, the amplitude threshold used in the calculating process of the measurement speed using the IF signal is changed to be small. Therefore, it is possible to increase a possibility to calculate the measurement speed from each of the IF signals obtained from the plurality of the millimeter wave radar modules. Thus, according to the speed measurement device 30 of this example, the measurement speed can be calculated from the plurality of the millimeter wave radar modules, so that a total reliability of the calculated measurement speed can be effectively improved.

### Fifth Example

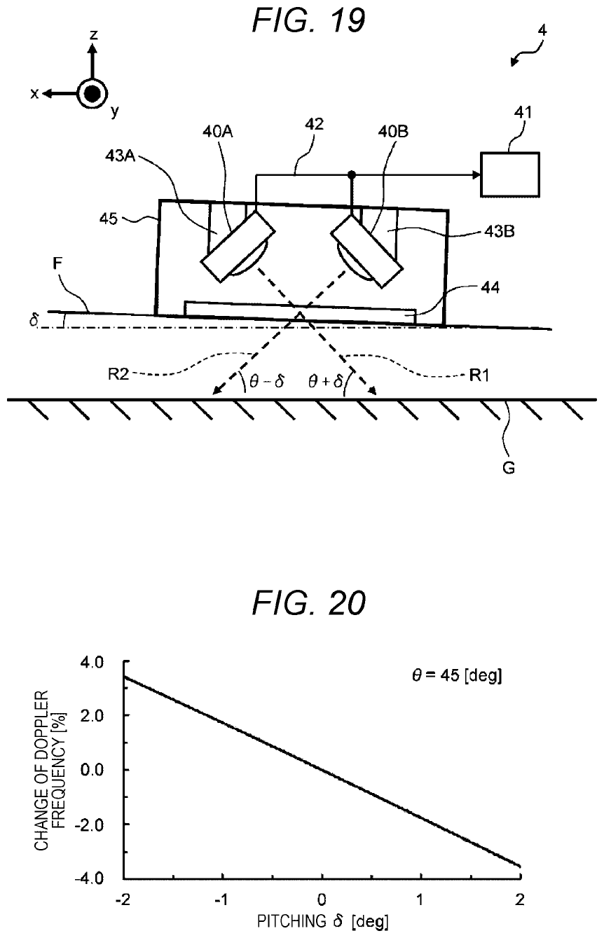

FIG. 19 is a diagram (Part 3) illustrating an example of the vehicle according to the fourth embodiment. A vehicle 4 illustrated in FIG. 19 is a vehicle which travels on the ground G (traveling path), and includes an external device 41 and an exterior housing 45 which has a transmission window 44 of the electromagnetic wave. The exterior housing 45 is fixed to the floor F of the vehicle 4. In the inside of the exterior housing 45, speed measurement devices 40A and 40B are fixed by fixing brackets 43A and 43B respectively. The speed measurement devices 40A and 40B and the external device 41 are connected through a communication line 42. Further, the internal configuration of the speed measurement devices 40A and 40B may be considered similar to that of the speed measurement device 10 illustrated in FIG. 2, and the description will be omitted.

As illustrated in FIG. 19, in the vehicle 4, the electromagnetic wave R1 is emitted from the speed measurement device 40A, and the electromagnetic wave R2 is emitted from the speed measurement device 40B. However, the irradiation positions of the traveling path (the around G) caused by the electromagnetic waves are different.

In this way, in a case where the irradiation positions of the traveling path caused by the electromagnetic waves R1 and R2 emitted from the speed measurement devices 40A and 40B are different, it is assumed that there occurs a difference in intensity of the reflection waves of the respective irradiation waves. At this time, there may occur a case where the measurement speed v is calculated only from the IF signal obtained by any one of the speed measurement devices (the measurement speed v is calculated as “0” from the IF signal in any one of the speed measurement devices).

Specifically, for example, it is assumed a case where the measurement speed v₁ is calculated from the IF signal obtained by the speed measurement device 40A, and the speed measurement device 40B is not possible to calculate the measurement speed v₂ from the obtained IF signal because the intensity of the reflection wave from the ground G is weak (the measurement speed v₂ becomes “0”).

At this time, the speed measurement device 40B obtains information indicating that the speed measurement device 40A is possible to calculate the measurement speed v₁ through the communication line 42 to estimate that the vehicle 4 is traveling, so that the amplitude threshold used in the calculating process of the measurement speed in the speed measurement device 40B may be changed to be smaller. This process is similar to that in the fourth example described above, and the measurement speed v₂ can also be expected to be calculated by changing the amplitude threshold of the speed measurement device 40B to be small.

In addition, in the vehicle 4, the external device 41 may be configured to collect information on whether the measurement speeds v₁ and v₂ are calculated in the speed measurement devices 40A and 40B, respectively. With such a configuration, as described above, in a case where the measurement speed v₁ is calculated while the measurement speed v₂ is not calculated, the external device 41 may transmit, to the speed measurement device 40B, information indicating that the measurement speed v₁ is calculated by the speed measurement device 40A, and the speed measurement device 40B may change the amplitude threshold to be small on the basis of the information. Further, in this case, the speed measurement device 40A and the external device 41, and the speed measurement device 40B and the external device 41 may be connected by the separated communication lines 42 so as to be configured in a one-to-one connection.

Further, in the vehicle 4 illustrated in FIG. 19, the speed measurement devices 40A and 40B are disposed to make the electromagnetic wave R1 and the electromagnetic wave R2 emit and intersect with each other. The transmission window 44 of the electromagnetic wave is disposed at a place where the electromagnetic waves R1 and R2 intersect. With such a layout, the transmission window through which the electromagnetic wave R1 transmits and the transmission window through which the electromagnetic wave R2 transmits can be shared by the transmission window 44. Therefore, the length of the exterior housing 45 can be made short in the x direction, and the space for the exterior housing 45 can be saved.

By the way, in FIG. 19, there is caused pitching between the ground G and the exterior housing 45. The ground G and the floor F of the vehicle 4 (the bottom of the exterior housing 45) is not parallel to each other. As illustrated in FIG. 19, if an elevation angle of the pitching is δ, the incident angle on the around G of the electromagnetic wave R1 is expressed by θ+δ, and the incident angle on the ground G of the electromagnetic wave R2 is expressed by θ−δ. When there occurs the pitching, the incident angle on the ground G of the electromagnetic wave does not become 9, and thus the frequency (the Doppler frequency) is changed by the Doppler effect. Specifically, the incident angle becomes (θ+δ) or (θ−δ) in Expression (1), and the peak frequency f_{d} of the IF signal is changed (hereinafter, the change is called a Doppler frequency change amount).

FIG. 20 is a diagram illustrating a relation example between the angle of the pitching and the Doppler frequency change amount. FIG. 20 illustrates a relation between elevation angle δ of the pitching and the Doppler frequency change amount caused by the elevation angle in a case where the incident angle θ is 45°. According to FIG. 20, the change in the pitching near the angle θ and the change of the Doppler frequency are proportional. Therefore, as illustrated in FIG. 19, the Doppler frequency change amount caused by the pitching can be canceled by emitting the electromagnetic waves R1 and R2 at the angle θ in the reverse direction to each other. Further, it is possible to reduce (almost “0”) an error of a calculation value of the measurement speed caused by the pitching.

However, the cancellation of the change of the Doppler frequency caused by the generation of the pitching described above can be applied in a limited way to a case where the measurement timings of the speed measurement devices 40A and 40B are matched. In a case where the measurement timings are not matched, there is left a possibility that the error caused by the pitching is not possible to be reduced.

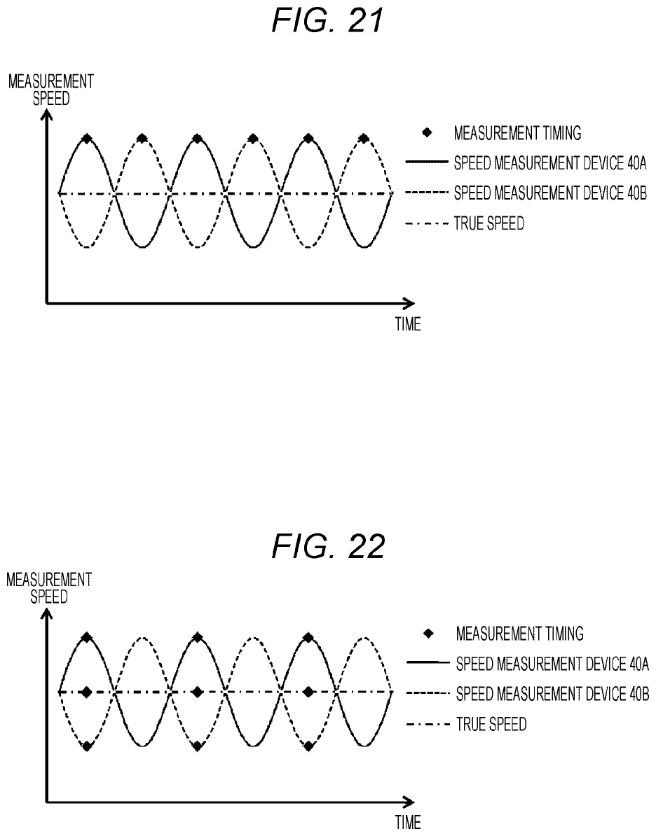

FIG. 21 is a diagram for describing a relation of a calculation value of the measurement speed in a case where the measurement timings are not matched. Since the measurement timings (for example, the incident timings of the reflection waves, etc.) in the speed measurement devices 40A and 40B are not matched in a case where the pitching occurs, the calculated measurement speeds are likely to be different. More specifically, if the measurement timings are different, there is a concern that the incident angles of the electromagnetic waves R1 and R2 with respect to the ground G become different according to the pitching. As a result, the peak values f_{d} of the amplitude spectrum of the IF signal obtained by the speed measurement devices 40A and 40B become different (see Expression (1)), and the calculation value of the measurement speed also becomes different. Then, as illustrated in FIG. 21, it cannot be said that an appropriate speed (“true speed” in FIG. 21) from which the influence of the pitching is removed is obtained even if an average of the measurement speeds calculated at different timings is taken.

To solve such a problem, the speed measurement devices 40A and 40B mounted in the vehicle 4 each calculate an average value of the measurement speeds which are calculated individually while matching the measurement timings to cancel the error caused by the pitching, so that the “true speed” can be obtained. FIG. 22 illustrates a specific image.

FIG. 22 is a diagram for describing a relation of the calculation value of the measurement speed in a case where the measurement timings are matched. According to FIG. 22, it can be seen that the error caused by the pitching has the equal absolute value in an opposite sign by matching the measurement timings of the speed measurement devices 40A and 40B. Therefore, it is possible to obtain the true speed from which the influence of the pitching is removed by calculating the average value of the measurement speeds calculated by speed measurement devices 40A and 40B.

Further, as described above, as a method of matching the measurement timings, for example, there is a method in which the signal transmitted from the one speed measurement device (for example, the speed measurement device 40A) is received by the other speed measurement device (for example, the speed measurement device 40B) so as to synchronize the start timing of the speed measurement of the speed measurement device 40B with the speed measurement device 40A. In addition, for example, the signal transmitted from the external device 41 is received by the speed measurement devices 40A and 40B at the same time, so that the start timing of the speed measurement may be synchronized with the signal.

### Sixth Example

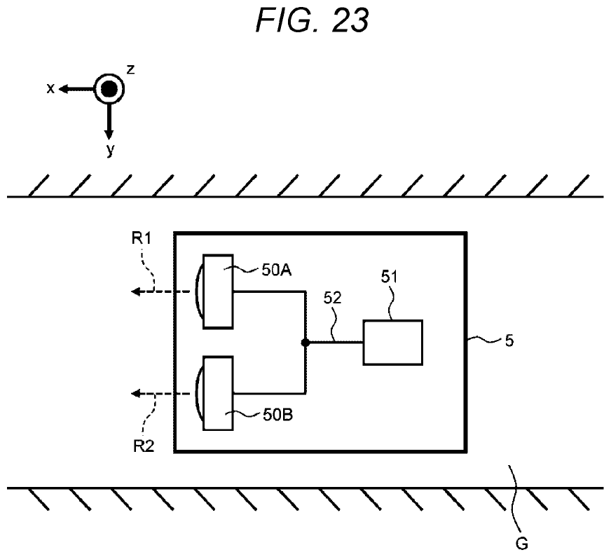

FIG. 23 is a diagram (Part 4) illustrating an example of the vehicle according to the fourth embodiment. FIG. 23 is a schematic diagram when a vehicle 5 is viewed from above. The vehicle 5 is configured such that two speed measurement devices 50A and 50B are connected to an external device 51 through a communication line 52. The internal configuration of the speed measurement devices 50A and 50B may be considered similar to that of the speed measurement device 10 illustrated in FIG. 2, and the description will be omitted.

Herein, comparing the vehicle 5 illustrated in FIG. 23 with the vehicle 4 illustrated in FIG. 19, two speed measurement devices connected to the external device are provided similarly, but the following points are different. In other words, in the vehicle 4 illustrated in FIG. 19, the electromagnetic wave R1 emitted from the speed measurement device 40A and the electromagnetic wave R2 emitted from the speed measurement device 40B take the same path on the ground G (traveling path). However, in the vehicle 5 illustrated in FIG. 23, the electromagnetic wave R1 emitted from the speed measurement device 50A and the electromagnetic wave R2 emitted from the speed measurement device 50B take different paths.

Herein, the difference in intensity of the reflection wave may be different depending on a path because of the state of the traveling path. In such a case, if there is one path where the electromagnetic wave is emitted, there may be situation where the measurement speed is not calculated sufficiently. With this regard, the vehicle 5 is configured, as illustrated in FIG. 23, such that the electromagnetic waves R1 and R2 are emitted to different paths, and even in a case where the electromagnetic waves from the ground G are different in reflectance according to the paths, information indicating that any one speed measurement device calculates the measurement speed is transmitted to the other speed measurement device. Therefore, the amplitude threshold used in the calculating process of the measurement speed in the other speed measurement device can be changed. Thus, the vehicle 5 can easily calculate the measurement speed by both the speed measurement devices.

Further, the speed measurement device 50A and the speed measurement device 50B do not directly transfer the information, but the external device 51 may relay or collect the information to transfer the current situation to the speed measurement devices 50A and 50B.

In addition, the speed measurement devices mounted in the vehicle 5 may be equal to or more than three devices. For example, in a case where three speed measurement devices are mounted, when the measurement speed can be calculated by two speed measurement devices, the left one speed measurement device which cannot calculate the measurement speed (the measurement speed is “0”) may be configured to change the amplitude threshold to be small. In addition, when two speed measurement devices cannot calculate the measurement speed, the left one speed measurement device which can calculate the measurement speed may be configured to change the amplitude threshold to be large.

Hitherto, the embodiments of the invention have been described. Other than the above-described specific examples, the speed measurement device (or the vehicle where the speed measurement device is mounted) according to the invention may determine whether the amplitude threshold is changed using various “system states”. For example, in an automobile, information indicating the state of the vehicle such as an engine rotation speed, or information indicating an operation state of the vehicle such as an accelerator or a brake may be used as the “system state”. In a railway vehicle, the speed information measured by a tacho-generator may be used as the “system state”. Further, in a speed measurement device installed on a road, detection information of the vehicle running on the traveling path may be used as the “system state”.

Further, the invention is not limited to the above embodiments, and various modifications can be made. For example, the above-described embodiments of the invention have been described in detail in a clearly understandable way. The invention is not necessarily limited to those having all the described configurations.

In addition, in the drawings, the control lines and the signal lines considered to be necessary for the explanation are illustrated, but not all the control lines and the signal lines required for a product are illustrated.

Further, the speed measurement device 10 configured as described in FIG. 2 may measure a distance to an object by adjusting the frequency generated by the oscillator 115 and by Performing the signal processing on the received wave. Therefore, even in a device which measures a distance to an object, the above-described embodiments may also be applied to a configuration of changing the amplitude threshold according to a condition of detection/non-detection of the object.

### REFERENCE SIGNS LIST

1 vehicle
10 speed measurement device
11 external device
12 communication line
110 millimeter wave radar module
111 IC chip
112 antenna
113 port
114 feeder line
115 oscillator
116 transmission amplifier
117 isolator
118 reception amplifier
119 mixer
120 lens
130 IF signal amplifier
140 calculation circuit
141 ADC
142 CPU
21 speed measurement device
22 acceleration sensor
23, 26 vehicle
24 rotation speed detection sensor
310A, 310B millimeter wave radar module
311A, 311B IC chip
312A, 312B antenna
320A, 320B lens
330A, 330B IF signal amplifier
340 calculation circuit
341A, 341B ADC
342 CPU
4 vehicle
40A, 40B speed measurement device
41 external device
42 communication line
43A, 43B fixing bracket
44 transmission window
45 exterior housing

1. A speed measurement device which measures a speed of a mounted system, comprising:
an irradiation unit which generates an irradiation wave caused by an electromagnetic wave or a sonic wave, and emits the wave to an external object;
a reception unit which receives a reflection wave from the object of the irradiation wave emitted from the irradiation unit;
a signal generation unit which generates a frequency difference signal which indicates a frequency difference between the irradiation wave generated by the irradiation unit and the reflection wave received by the reception unit;
a speed calculation unit which calculates a measurement speed on the basis of the frequency difference signal in a case where an intensity of the frequency difference signal generated by the signal generation unit is equal to or more than a Predetermined value; and
a threshold change unit which changes the predetermined value used in the speed calculation unit when measuring a speed next time on the basis of a state of the system.

2. The speed measurement device according to claim 1,
wherein the threshold change unit changes the predetermined value on the basis of the speed of the system.

3. The speed measurement device according to claim 1,
wherein the threshold change unit changes the predetermined value to a smaller value in a case where the measurement speed calculated by the speed calculation unit is equal to or more than a predetermined speed.

4. The speed measurement device according to claim 1,
wherein the threshold change unit changes the predetermined value to a larger value in a case where the measurement speed calculated by the speed calculation unit is less than a predetermined speed.

5. The speed measurement device according to claim 1,
wherein the threshold change unit changes the predetermined value to a smaller value in a case where a state that the measurement speed calculated by the speed calculation unit is equal to or more than a predetermined speed continues a predetermined number of times.

6. The speed measurement device according to claim 1,
wherein the threshold change unit changes the predetermined value to a smaller value in a case where a state that the measurement speed calculated by the speed calculation unit is less than a predetermined speed continues a predetermined number of times.

7. The speed measurement device according to claim 1,
wherein different values are used for the predetermined value according to a speed.

8. The speed measurement device according to claim 1, further comprising:
a state reception unit which receives a signal indicating a state of the system from an outside,
wherein the threshold change unit changes the predetermined value on the basis of the signal received by the state reception unit.

9. The speed measurement device according to claim 1, further comprising:
a plurality of irradiation units which emit the irradiation wave to different irradiation ranges of the object,
wherein the signal generation unit generates the frequency difference signal related to each of the irradiation waves emitted from the plurality of irradiation units,
wherein the speed calculation unit calculates the measurement speed for each of a plurality of the frequency difference signals generated by the signal generation unit, and
wherein the threshold change unit changes the predetermined value used to calculate another measurement speed on the basis of any one of the plurality of measurement speeds calculated by the speed calculation unit.

10. The speed measurement device according to claim 1,
wherein the system is a vehicle, and the object is a traveling path of the vehicle.

11. A speed measurement method of a speed measurement device which measures a speed of a mounted system, comprising:
an emitting step of generating an irradiation wave caused by an electromagnetic wave or a sonic wave and emitting the wave to an external object;
a receiving step of receiving a reflection wave from the object of the irradiation wave emitted in the emitting step;
a signal generating step of generating a frequency difference signal indicating a frequency difference between the irradiation wave generated in the emitting step and the reflection wave received in the receiving step;
a speed calculating step of calculating a measurement speed on the basis of the frequency difference signal in a case where an intensity of the frequency difference signal generated in the signal generating step is equal to or more than a predetermined value; and
a threshold changing step of changing the predetermined value used in the speed calculating step when measuring a speed next time on the basis of a state of the system.

12. The speed measurement method according to claim 11,
wherein, in the threshold changing step, the predetermined value is changed on the basis of the speed of the system.

13. The speed measurement method according to claim 11,
wherein, in the threshold changing step, the predetermined value is changed to a smaller value in a case where the measurement speed calculated in the speed calculating step is equal to or more than a predetermined speed.

14. The speed measurement method according to claim 11,
wherein, in the threshold changing step, the predetermined value is changed to a smaller value in a case where a state that the measurement speed calculated in the speed calculating step is equal to or more than a predetermined speed continues a predetermined number of times.

15. The speed measurement method according to claim 11,
wherein, in the emitting step, a plurality of irradiation units emit the irradiation wave to different irradiation ranges of the object,
wherein, in the signal generating step, the frequency difference signal related to each irradiation wave emitted in the emitting step is generated,
wherein, in the speed calculating step, the measurement speed is calculated for each of the plurality of frequency difference signals generated in the signal generating step, and
wherein, in the threshold changing step, the predetermined value used to calculate another measurement speed is changed on the basis of any one of the plurality of measurement speeds calculated in the speed calculating step.
